(19) United States
(12) Patent Application Publication
(10) Pub. No.: US 2006/0075184 A1
(43) Pub. Date: Apr. 6, 2006

(54) SYNCHRONOUS\ASYNCHRONOUS MEMORY DEVICE WITH SINGLE PORT MEMORY UNIT

(76) Inventor: Jen-Ying Chen, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,738

(22) Filed: Oct. 1, 2004

(51) Int. Cl. G06F 13/00

(52) U.S. Cl. 711/104; 711/168

(57) ABSTRACT

A synchronous\asynchronous memory device includes a single port memory unit for storing data according to a read clock, a configurable write buffer for storing data according to a write clock and for transferring the stored data to the single port memory unit according to the read clock, a write blocking logic for controlling the configurable write buffer to store data according to a remaining data storage capability of the configurable write buffer and for controlling the configurable write buffer to transfer the stored data to the single port memory unit according to a write acknowledge signal, and an arbiter electrically connected to the write blocking logic and the single port memory unit for generating the write acknowledge signal.

### BACKGROUND OF INVENTION

1. Field of the Invention

The present invention relates to a memory device, and more particularly, to a synchronous\asynchronous memory device with a single port memory unit.

2. Description of the Prior Art

First-in first-out (FIFO) and last-in first-out (FILO) are two types of memory devices electrically connected between a first computer system, which operates on a first clock, and a second computer system, which operates on a second clock, to store data (instructions) generated by the first computer system according to the first clock and to transfer its stored data to the second computer system according to the second clock.

Please refer to FIG. 1, which is a function block diagram of a FIFO 10 according to the prior art. The FIFO 10 comprises a dual port memory unit 12, a write pointer 14 electrically connected to the dual port memory unit 12, and a read pointer 16 electrically connected to the dual port memory unit 12.

How the FIFO 10 stores the data generated by the first computer system and transfers its stored data to the second computer system is described briefly as follows: When the FIFO 10 receives a write enable signal WE output by the first computer system, the data generated by the first computer system are stored via a write data bus B[n:0] into a data storage space of the dual port memory unit 12 pointed by the write pointer 14 according to the first clock; On the other hand, when the FIFO 10 receives a read enable signal RE output by the second computer system, data stored in a data storage space of the dual port memory unit 12 pointed by the read pointer 16 are transferred via a read data bus A[n:0] to the second computer system according to the second clock.

In the FIFO 10, a write clock WCLK is not required to be synchronous to a read clock RCLK, and the FIFO 10 can be applied to two computer systems whose operating clocks are different from each other. Moreover, implemented with the dual port memory unil 2, which can receive the read enable signal RE and the write enable signal WE at the same time, the FIFO 10 can transfer its stored data to the second computer system at a moment when data generated by the first computer system are stored into the FIFO 10.

However, the FIFO 10 has to have a delicate circuit extra implemented to execute the above-mentioned write function and read function simultaneously. The extra-implemented circuit not only increases the cost of the FIFO 10, but also complicating the FIFO 10 and decreasing the data-accessing efficiency of the FIFO 10.

A U.S. Pat. No. 5,371,877 is disclosed to overcome the drawbacks of high cost and low data-accessing efficiency. A FIFO 20, which can be electrically connected between a third computer system and a fourth computer system, comprises two single port memory units 22 and 23.

How the FIFO 20 stores data generated by the third computer system and transfers its stored data to the fourth computer system is described briefly as follows: Date generated by the third computer system are alternatively stored into those two single port memory units 22 and 23 according to a first phase and a second phase of an operating clock respectively. For example, the first phase can be synchronous to a rising edge of the operating clock, the second phase can be synchronous to a falling edge of the operating clock, and odd-number ordered data generated by the third computer system are to be stored into the single port memory unit 22 according to the rising edge of the operating clock and even-number ordered data generated by the third computer system are to be stored to the single port memory unit 23 according to the falling edge of the operating clock; On the other hand, data stored in those two single port memory units 22 and 23 are to be alternatively transferred to the fourth computer system according to the falling edge and the rising edge of the operating clock respectively.

In short, when data stored in the single port memory unit 23 are transferred to the fourth computer system, the odd-number ordered data generated by the third computer system are stored into the single port memory unit 22; On the other hand, when data stored in the single port memory unit 22 are transferred to the fourth computer system, the even-number ordered data generated by the third computer system are stored into the single port memory unit 23.

Having those two single port memory units 22 and 23, which are simple and cheap than the dual port memory unit 12, the FIFO 20 can execute the write and the read functions simultaneously. However, the first phase and the second phase, according to which the FIFO 20 executes the write and read functions simultaneously, are in fact identical and equal to the operating clock, so the FIFO 20 can only be applied to two computer systems whose operating clocks are identical.

### SUMMARY OF INVENTION

It is therefore a primary objective of the claimed invention to provide a synchronous\asynchronous memory device having a single port memory unit and still capable of executing the write and read functions simultaneously.

According to the claimed invention, the synchronous memory device includes the single port memory unit for storing data according to a read clock; a configurable write buffer electrically connected to the single port memory unit for storing data according to a write clock and for transferring its stored data to the single port memory unit according to the read clock; a write blocking logic electrically connected to the configurable write buffer for estimating a remaining data storage capacity of the configurable write buffer and controlling the configurable write buffer to store data according to the write clock, and for controlling the configurable write buffer to transfer its stored data to the single port memory unit according to a write acknowledge signal; and an arbiter electrically connected to the write blocking logic and the single port memory unit for generating the write acknowledge signal.

According to the preferred embodiment, the write blocking logic includes a write counter for counting the remaining data storage capability of the configurable write buffer; a read counter for counting how many data in the configurable write buffer ready to be transferred to the single port memory unit; a read\write synchronizer electrically connected between the write counter and the read counter for changing signals synchronizing with the read clock to signals synchronizing with the write clock; a write\read synchronizer electrically connected between the write counter and the read counter for changing signals synchronizing with the write clock to signals synchronizing with the read clock; a write comparator electrically connected to the write counter for comparing the remaining data storage capacity of the configurable write buffer counted by the write counter with a first predetermined count value and controlling the configurable write buffer to store data; a read comparator electrically connected to the read counter for comparing how many data in the configurable write buffer ready to be transferred to the single port memory unit with a second predetermined count value and controlling the configurable write buffer to transfer its stored data to the single port memory unit according to the read clock; a write select counter electrically connected to the write counter for counting how many data the configurable write buffer has ever stored and generating a write select value; a read select counter electrically connected to the read counter for counting how many data the configurable write buffer has ever transferred to the single port memory unit and generating a read select value; and the configurable write buffer includes a plurality of buffer modules for storing data; a demultiplexer electrically connected to the buffer modules for storing data to one of the buffer modules according to the write select value; and a multiplexer electrically connected to the buffer modules for transferring data stored in one of the buffer modules to the single port memory unit according to the read select value.

It is an advantage of the claimed invention that a FIFO having a single port memory unit, a configurable write buffer, a write blocking logic, and an arbiter can have a gate count as small as possible and is cheap in cost.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of a FIFO according to the prior art.

FIG. 2 is a function block diagram of a FIFO of the preferred embodiment according to the present invention.

FIG. 3 is a waveform diagram showing a read clock RCLK, a write synchronous signal fwr_sync, a write acknowledge signal fwr_ack, and a read enable signal frd in the FIFO shown in FIG. 2 according to the present invention.

FIG. 4 is a function block diagram of a write blocking logic of the FIFO shown in FIG. 2 according to the present invention.

FIG. 5 is a waveform diagram showing a write clock WCLK, a write enable signal fwr, and a write ready signal fwr_rdy in the write blocking logic shown in FIG. 4, a write count value in a write counter shown in FIG. 4, and a write acknowledge signal fwr_ack generated by an arbiter in the FIFO shown in FIG. 2 according to the present invention.

FIG. 6 is a function block diagram of a configurable write buffer of the FIFO shown in FIG. 2 according to the present invention.

FIG. 7 is a function block diagram of a write blocking logic of a FIFO of a second embodiment according to the present invention.

FIG. 8 is a relation diagram between gate count and area for four SRAMs comprising the FIFOs of the prior and the present invention respectively.

### DETAILED DESCRIPTION

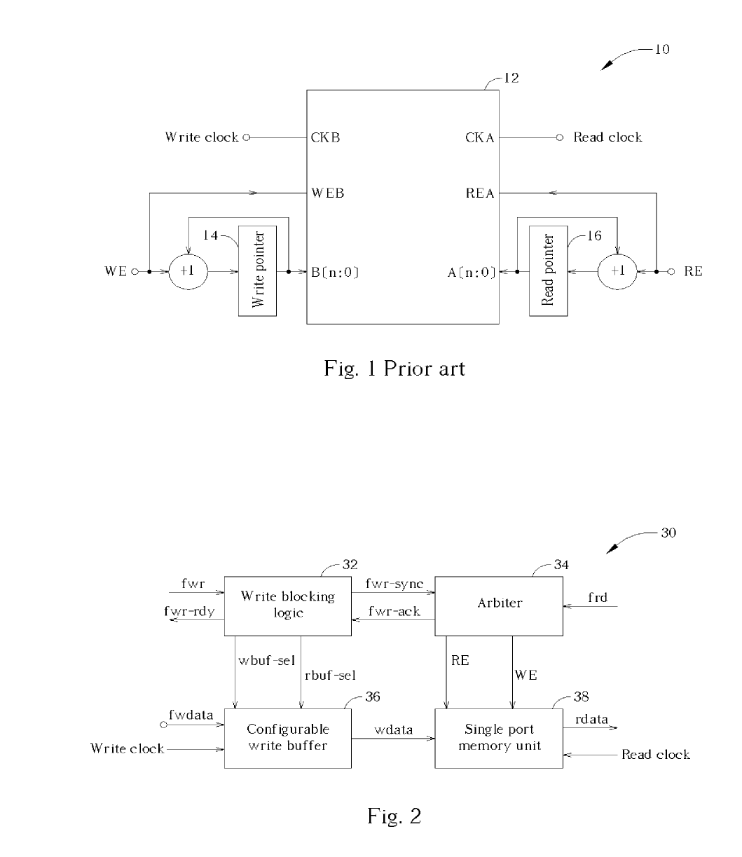

Please refer to FIG. 2, which is a function block diagram of a FIFO 30 of the preferred embodiment according to the present invention. The FIFO 30 can be electrically connected between a first computer system, which operates on a first clock, and a second computer system, which operates on a second clock. The first clock is not required to be synchronous to the second clock. The FIFO 30 comprises a write blocking logic 32, an arbiter 34 electrically connected to the write blocking logic 32, a configurable write buffer 36 electrically connected to the write blocking logic 32, and a single port memory unit 38 electrically connected between the arbiter 34 and the configurable write buffer 36. Data wdata input to the configurable write buffer 36 can be transferred and stored into the single port memory unit 38 according to the second clock (the read clock RCLK); On the other hand, data stored in the single port memory unit 38 can be transferred to the second memory system according to the read clock RCLK.

In the preferred embodiment, data fwdata ready to be stored into the FIFO 30 are stored into the configurable write buffer 36 first sequentially according to the first clock (the write clock WCLK). When the FIFO 30 receives the data fwdata and a write enable signal fwr (the same as the write enable signal WE output from the first computer system shown in FIG. 1) transferred from the first computer system, the write blocking logic 32 estimates a remaining data storage capacity of the configurable write buffer 36 immediately. After estimating that the configurable write buffer 38 still has some data storage spaces available, the write blocking logic 32 transfers a write ready signal fwr_rdy to the first computer system to report that the data fwdata transferred by the first computer to the FIFO 30 have been stored into the configurable write buffer 38. After receiving the write ready signal fwr_rdy, the first computer system can then transfer next data to the FIFO 30 again. On the contrary, the write blocking logic 32 will not transfer the write ready signal fwr_rdy to the first computer system after estimating that the configurable write buffer 32 is too full to store any extra data, and the data fwdata generated by the first computer system ready to be stored into the FIFO 30 still stay in the first computer system. The first computer system keeps polling the write enable signal fwr and the data fwdata to the FIFO 30 until receiving the write ready signal fwr_rdy—the configurable write buffer 36 has some data storage spaces left and the data fwdata have been stored into the configurable write buffer 36.

The write enable signal fwr will be further transferred into a write\read synchronizer 40 to be changed into a write synchronous signal fwr_sync, which is synchronous to the read clock RCLK. The arbiter 34 arbitrates the priorities of the write synchronous signal fwr_sync and a read enable signal frd (the same as read enable signal RE transferred from the second computer system shown in FIG. 1) and transfers a write acknowledge signal fwr_ack to the write blocking logic 32. After the write blocking logic 32 has received the write acknowledge signal fwr_ack, data mdata stored in the configurable write buffer 36 can be transferred and stored into the single port memory unit 38.

In the preferred embodiment, in order not to overflow the single port memory unit 38, the read enable signal frd is assumed to have a priority higher than that of the write synchronous signal fwr_sync. In such a scenario, the data mdata stored in the configurable write buffer 36 will be not transferred into the single port memory unit 38 unless the second computer system needs to read data rdata stored in the single port memory unit 38 and does not transfer the read enable signal frd to the FIFO 30, causing the configurable write buffer 36 to have more data storage spaces. On the contrary, when the second computer system needs to read the data rdata stored in the single port memory unit 38 and transfers the read enable signal frd to the FIFO 30, the arbiter 34 will not generate the write acknowledge signal fwr_ack, and the data mdata stored in the configurable write buffer 36 will be neither transferred nor stored into the single port memory unit 38.

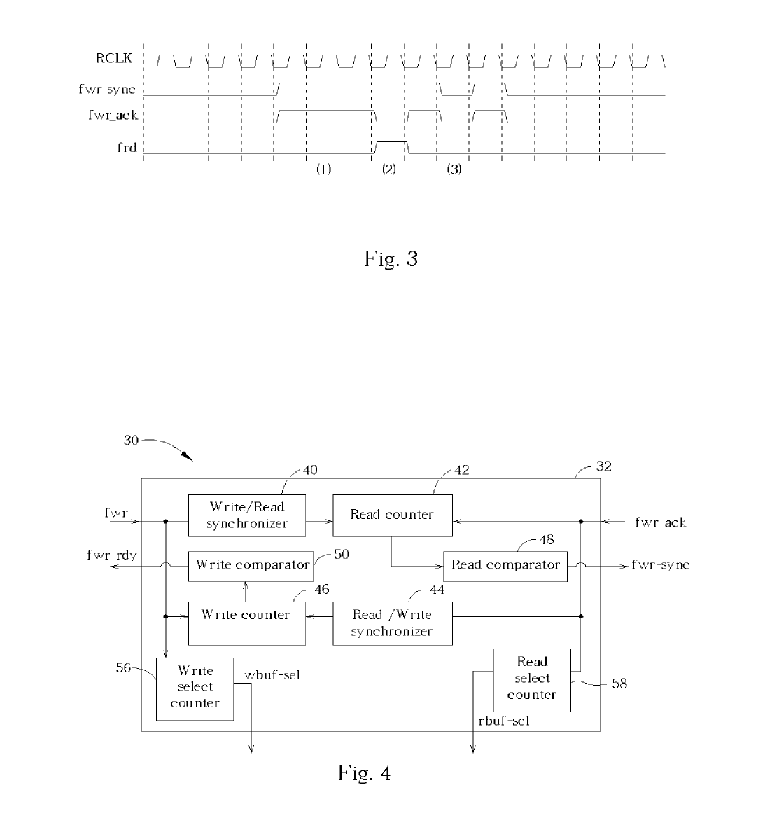

Please refer to FIG. 3, which is a waveform diagram showing the read clock RCLK, the write synchronous signal fwr_sync, the write acknowledge signal fwr_ack, and the read enable signal frd in the FIFO 30 according to the present invention. FIG. 3 shows that (1) when the read enable signal frd is a logic low voltage, implying that the second computer system needs not to read the data rdata stored in the single port memory unit 38, and the write synchronous signal fwr_sync is a logic high voltage, implying that the first computer system is ready to transfer the data fwdata to the FIFO 30, the arbiter 34 generates the write acknowledge signal fwr_ack, and the data mdata stored in the configurable write buffer 36 can be transferred and stored into the single port memory unit 38; (2) when the read enable signal frd is the logic high voltage, implying that the second computer system needs to read the data rdata stored in the single port memory unit 38, and the write synchronous signal fwr_sync is still the logic high voltage, implying that the first computer system is ready to transfer the data fwdata to the FIFO 30, since the real enable signal frd is assumed to have a priority higher than that of the write synchronous signal fwr_sync, the arbiter 34 does not generate the write acknowledge signal fwr_ack (as shown in FIG. 3, the write acknowledge signal fwr_ack is the logic low signal), and the data mdata stored in the configurable write buffer 36 cannot be transferred and stored into the single port memory unit 38; and (3) when the read enable signal frd is the logic low voltage, and the write synchronous signal fwr_sync is the logic low voltage as well, implying that the first computer system is not ready to transfer the data fwdata to the FIFO 30, the arbiter 34 does not generate the write acknowledge signal fwr_ack.

Please refer to FIG. 4, which is a function block diagram of the write blocking logic 32 of the FIFO 30 of the preferred embodiment according to the present invention. The write blocking logic 32 comprises the write\read synchronizer 40, a read counter 42 electrically connected to the write\read synchronizer 40, a read\write synchronizer 44 electrically connected to the read counter 42, a write counter 46 electrically connected between the read\write synchronizer 44 and the write\read synchronizer 40, a read comparator 48 electrically connected to the read counter 42, a write comparator 50 electrically connected to the read counter 46, a write select counter 56 electrically connected to the write\read synchronizer 40, and a read select counter 58 electrically connected to the read\write synchronizer 44.

Similar to the write\read synchronizer 40, the read\write synchronizer 44 is implemented to change the write acknowledge signal fwr_ack synchronous to the read clock RCLK into another write acknowledge signal fwr_ack synchronous to the write clock WCLK.

The write counter 46 is implemented to count a remaining data storage capability of the configurable write buffer 36 and has an initial value assumed to be equal to how many data fwdata that the configurable write buffer 36 can store. Every time the FIFO 30 receives the write enable signal fwr output from the first computer system and estimates that the configurable write buffer 36 still has some data storage spaces left and generates the write ready signal fwr_rdy, a write count value of the write counter 46 is decreased by one; On the other hand, every time the write blocking logic 32 receives the write acknowledge signal fwr_ack transferred from the arbiter 34 and transfers the data mdata stored in the configurable write buffer 36 into the single port memory unit 38, the write count value of the write counter 46 is increased by one. As long as the write comparator 50 compares that the write count value of the write counter 46 is not equal to zero, implying that the configurable write buffer 36 still has some data storage spaces left, the write blocking logic 32 generates the write ready signal fwr_rdy, and the first computer system can transfer next data fwdata to the FIFO 30.

The write select counter 56 downward counts how many write ready signals fwr_rdy that the FIFO 30 has ever generated. The write select counter 56 has a write select initial value assumed to be equal to how many data fwdata that the configurable write buffer 36 can store. Every time the FIFO 30 receives the write enable signal fwr output from the first computer system and estimates that the configurable write buffer 36 still has some data storage spaces left and generates the write ready signal fwr_rdy, a write select count value wbuf_sel of the write select counter 56 is decreased by one. When the write select count value wbuf_sel is decreased to be equal to zero and the FIFO 30 still generates the write ready signal fwr_rdy, the write select count value wbuf_sel of the write select counter 56 is reset to be equal to the write initial select value.

Similar to the write counter 46, the read counter 42 is implemented to count how many data left in the configurable write buffer 36 has to be transferred to the single port memory unit 38. The read counter has an initial value assumed to be equal to zero. Every time the FIFO 30 receives the write enable signal fwr output from the first computer system and generates the write synchronous signal fwr_syc, a read count value of the read counter 42 is increased by one; On the other hand, every time the write blocking logic 32 receives the write acknowledge signal fwr_ack transferred from the arbiter 34 and transfers the data mdata stored in the configurable write buffer 36 into the single port memory unit 38, the read count value of the read counter 42 is decreased by one. As long as the read comparator 48 compares that the read count value of the read counter 42 is not equal to zero, implying that the configurable write buffer 36 still has some data rdata left to be transferred to the single port memory unit 38, the write blocking logic 32 keeps generating the write synchronous signal fwr_sync, and the data rdate stored in the configurable write buffer 38 are transferred to the single port memory unit 38.

The read select counter 58 downward counts how many write acknowledge signals fwr_ack that the write blocking logic 32 has ever received from the arbiter 34. The read select counter 58 has a read select initial value assumed to be equal to how many data fwdata that the configurable write buffer 36 can store. Every time the write blocking logic 32 receives the write acknowledge signal fwr_ack output from the arbiter 34 and transfers the data mdata stored in the configurable write buffer 36 to the signle port memory unit 38, a read select count value rbuf_sel of the read select counter 58 is decreased by one. When the read select count value rbuf_sel of the read select counter 58 is decreased to be equal to zero and the write blocking logic 32 still receives the write acknowledge signal fwr_ack, the read select count value rbuf_sel of the read select counter 58 is reset to be equal to the read initial select value.

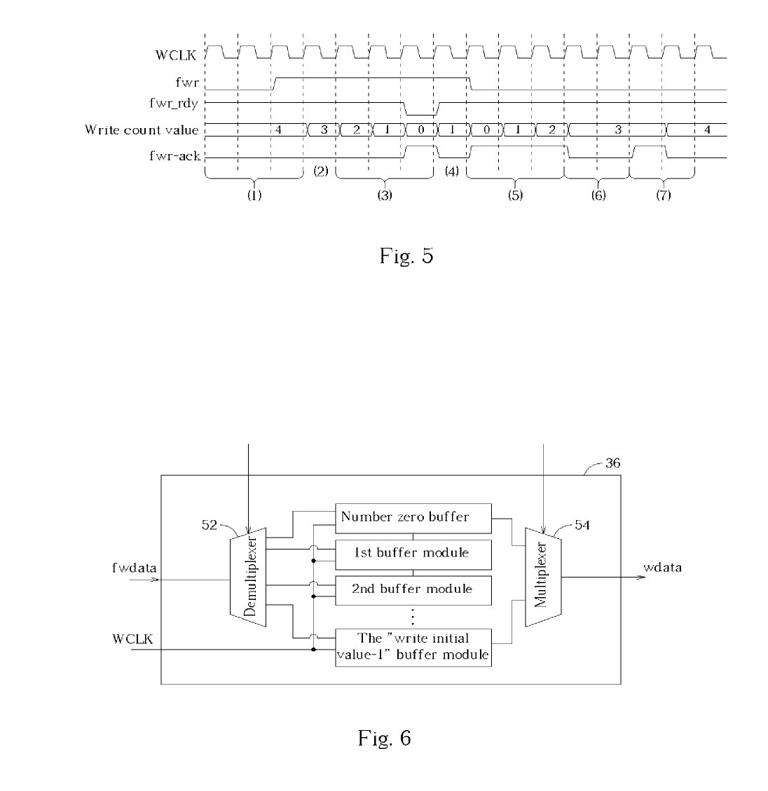

Please refer to FIG. 5, which is a waveform diagram showing the write clock WCLK, the write enable signal fwr, and the write ready signal fwr_rdy in the write blocking logic 32, the write count value of the write counter 46, and the write acknowledge signal fwr_ack generated by the arbiter 34 according to the present invention. FIG. 5 shows that (1) when the write count value of the write counter 46 is not equal to zero, as shown in FIG. 5 the write count value is equal to “4”, the write comparator 50 generates the write ready signal fwr_rdy, which has the logic high voltage as shown in FIG. 5; (2) Under a circumstance that the configurable write buffer 36 still has some data storage spaces available and the write comparator 50 accordingly generates the write ready signal fwr_rdy, when the FIFO receives the data fwdata output from the first computer system and the write enable signal fwr as well, and the arbiter 34 does not generate any write acknowledge signal fwr_ack, the FIFO 30 transfers the write ready signal fwr_rdy to the first computer system to report that the data fwdata transferred from the first computer system to the FIFO 30 have been stored in the configurable write buffer 36, and the write count value of the write counter 46 is decreased to be equal to “3” accordingly; (3) After the write count value of the write counter 46 have been decreased from “3”, via “2”, to “1” sequentially, the configurable write buffer 36 does not have any data storage spaces available to store the data fwdata transferred from the first computer system to the FIFO 30, and the write comparator 50 does not generate the write ready signal fwr_rdy, which has the logic low voltage as shown in FIG. 5, and the write count value of the write counter 46 is decreased to be equal to zero accordingly; (4) Under a circumstance that the configurable write buffer 36 does not have any data storage spaces left, when the FIFO 30 receives the data fwdata transferred from the first computer and the write enable signal fwr as well, and the arbiter 34 generates the write acknowledge signal fwr_ack (the data mdata stored in the configurable write buffer 36 are to be transferred to the single port memory unit 38), the write count value of the write counter 46 is increased from “0” to “1”, and the FIFO 30 transfers the write ready signal fwr_rdy to the first computer system accordingly; (5) When the FIFO 30 receive neither the data fwdata nor the write enable signal fwr transferred from the first computer system, and the arbiter 34 generates the write acknowledge signal fwr_ack, the write count value of the write counter 46 is increased from “0”, and the FIFO 30 transfers the write ready signal fwr_rdy to the first computer system accordingly; (6) When the FIFO 30 receives neither the data fwdata nor the write enable signal fwr transferred from the first computer system, and the arbiter 34 does not receive any write acknowledge signal fwr_ack, the write count value of the write counter 46 does not change and is still equal to “3” as shown in FIG. 5, and the FIFO 30 keeps transferring the write ready signal fwr_rdy to the first computer system; (7) When the FIFO 30 receives neither the data fwdata nor the write enable signal fwr transferred from the first computer system, but the arbiter 34 generates the write acknowledge signal fwr_ack once again, the write count value of the write counter 46 is increased from “3” to “4”, and the FIFO 30 keeps transferring the write ready signal fwr_rdy to the first computer system.

Please refer to FIG. 6, which is a function block of the configurable write buffer 36. The configurable write buffer 36 comprises a demultiplexer 52 electrically connected to the write select counter 56 of the write blocking logic 32, a plurality of buffer modules, all of which are electrically connected to the demultiplexer 52, and a multiplexer 54 electrically connected between the buffer modules and the read select counter 58 of the write blocking logic 32. The data fwdata transferred from the first computer system to the FIFO 30 are stored into one of the buffer modules via the demultiplexer 52 of the configurable write buffer 36 according to the write select count value wbuf_sel of the write select counter 56. The data mdata stored in the buffer modules are transferred via the multiplexer 54 to the single port memory unit 38 according to the read select count value of the read select counter 58.

Of the preferred embodiment, the buffer modules of the configurable write buffer 36 are equal to the write initial value of the write counter 46 of the write blocking logic 32 in number. Of a FIFO of the present invention, the number of the buffer modules of the “configurable” write buffer 36 is configurable on demand. For example, if the write clock is far larger than the read clock RCLK in frequency, implying that a number of the data fwdata transferred by the first computer system to the FIFO 30 in a unit period is far larger than that of the data rdata that the FIFO 30 can transfer at most to the second computer system in the unit period, in order not to overflow the single port memory unit 38, the FIFO can comprise a configurable write buffer with more buffer modules implemented.

The demultiplexer 52 of the configurable write buffer 36 transfers the data fwdata transferred from the first computer system to one of the buffer modules according to the write select count value wbuf_sel of the write select counter 56. For example, if the configurable write buffer 36 of the FIFO 30 includes eight buffer modules from the number zero to the seventh, and the write select count value wbuf_sel of the write select counter 56 is equal to “1’, the demultiplexer 52 transfers the data fwdata output from the first computer system to the first buffer module of the eight buffer modules, and the write select count value wbuf_sel of he write select counter 58 is decreased to be equal to “0” accordingly; Sequentially, the demultiplexer 52 transfers the data fwdata output from the first computer system to the number zero buffer module, and the write select count value of the write select counter 56 is reset to be equal to “7” accordingly, implying that the demultiplexer 52 transfers the fwdata next output from the first computer system to the FIFO 30 to the seventh (the write initial value minus one) buffer module of the configurable write buffer 36.

The multiplexer 54 of the configurable write buffer 36 transfers the data mdata stored in one of the buffer modules to the single port memory unit 38 according to the read select count value rbuf_sel of the read select counter 58. For example, if the read select count value of the read select counter 58 is equal to “1”, the multiplexer 54 transfers the data mdata stored in the first buffer module of the eight buffer modules to the single port memory unit 38, and the read select count value rbuf_sel of the read select counter 58 is decreased to be equal to “0”; Sequentially, the multiplexer 54 transfers the data mdata stored in the number zero buffer module of the eight buffer modules to the single port memory unit 38, and the read select count value rbuf_sel of the read select counter 58 is reset to be equal to “7”, implying that the multiplexer 54 transfers the data mdata stored in the seventh buffer module of the configurable write buffer 36 to the single port memory unit 38 afterward.

According to the preferred embodiment, the write select counter 56, and the read select counter 58 as well, downward counts the write ready signal fwr_rdy and the write acknowledge signal fwr_ack, and have a write select initial value and the read select initial value both set to be equal to how many data fwdata the configurable write buffer 36 can store. However, a FIFO of the present invention can comprises a write blocking logic, whose write select counter upward counts the write ready signal fwr_rdy and has a write select initial value set to be equal to zero. Accordingly, the write blocking logic of the FIFO can comprise a read select counter upward counting the write acknowledge signal fwr_ack and having a read select initial value set to be equal to zero. Similarly, the write blocking logic of the FIFO can comprises a write counter upward counting how many data storage spaces left in the configurable write buffer 36 and having a write initial value set to be equal to zero. Accordingly, the write blocking logic comprises a write comparator and does not generate any write ready signal fwr_rdy until the write compares that the write count value of the write counter is not equal to how many data fwdata the configurable write buffer 36 can store.

The FIFO 30 shown in FIG. 2 and FIG. 3 can be applied to an asynchronous communications system—the first clock (the write clock WCLK) in the first computer system is not synchronous to the second clock (the read clock RCLK) in the second computer system. Of course, the FIFO of the present invention can be applied to a less-complicated synchronous communications system.

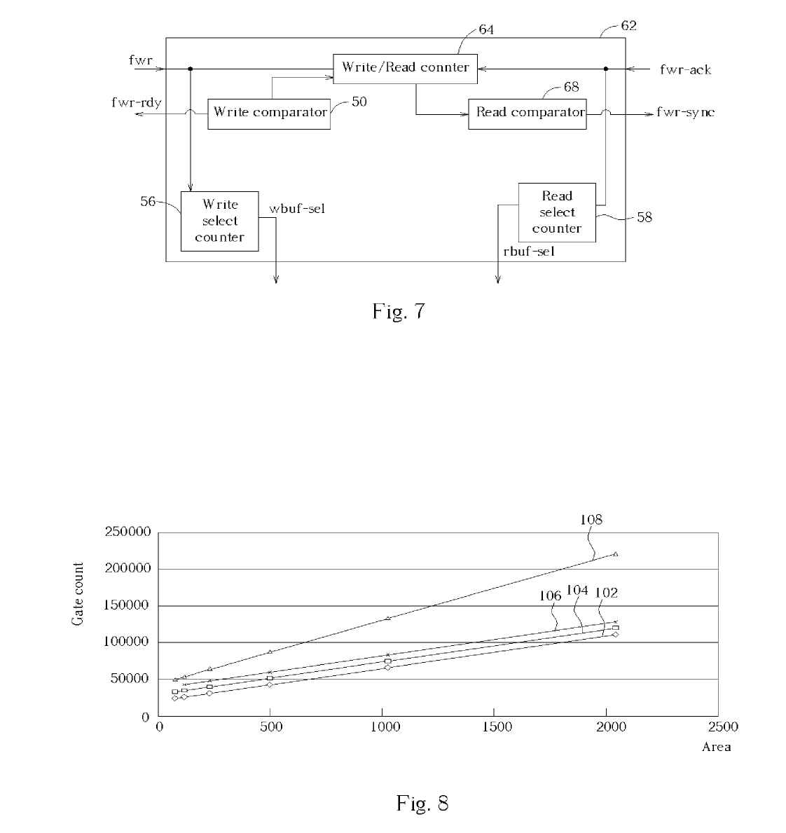

Please refer to FIG. 7, which is a function block diagram of a write blocking logic 62 of a FIFO 60 of a second embodiment according to the present invention. In addition to the configurable write buffer 36, the arbiter 34, and the single port memory unit 38, the FIFO 60 further comprises the write blocking logic 62 instead of the write blocking logic 32, which has a structure more complicated than that of the write blocking logic 62.

Since the FIFO 60 is applied to the synchronous communications system, the write blocking logic 62 can simply comprise the write comparator 50, a read comparator 68, the write select counter 56, the read select counter 58, and a single counter read\write counter 64, without the read\write synchronizer 40, the read\write synchronizer 44, and two counters, the write counter 46 and the read counter 42, which are all implemented in the write blocking logic 32 of the FIFO 30.

The write\read counter 64 is implemented to count the remaining data storage capacity of the configurable write buffer 36 and has a write\read initial value set to be equal to how many data fwdata the configurable write buffer 36 can store. Every the FIFO 60 receives the write enable signal fwr, and estimates the remaining data storage capacity of the configurable write buffer 36 and generates the write ready signal fwr_rdy, a write\read count value of the write\read counter 64 is decreased by one; On the other hand, every time the write blocking logic 62 receives the write acknowledge signal fwr_ack output from the arbiter 34 and transfers the data mdata stored in the configurable write buffer 36 to the single port memory unit 38, the write\read count value of the write\read counter 64 is increased by one. As long as the write comparator 50 compares that the write\read count value of the write\read counter 64 is not equal to zero, the write blocking logic 62 generates the write ready signal fwr_rdy, and the first compute system can keeps transferring next data fwdata to the FIFO 60; On the other hand, as long as the read comparator 68 compares that the write\read count value of the write\read counter 64 is not equal to how many data fwdata the configurable write buffer 36 can store, implying that the configurable write buffer 36 still has some data mdata stored to be transferred to the single port memory unit 38, the write blocking logic 62 keeps generating the write synchronous signal fwr_sync.

The read select counter 56 and the read select counter 58 of the FIFO 60 function the same as the write select counter 56 and the read select counter 58 of the FIFO 30, further description hereby omitted.

Please refer to FIG. 8, which is a relation diagram between gate count and area for four SRAMs, where an abscissa represents the area of an SRAM, and an ordinate the gate count (data storage capacity) of the SRAM. Under the occupation of the same area (having the same data storage capacity), a first SRAM, which comprises the FIFO 60 (applied to a synchronous communications system) and is indicated by a first curve 102, is the smallest one of the SRAMs in size, a second SRAM, which comprises the FIFO 30 (applied to an asynchronous communications system) and is indicated by a second curve 104, is the second smallest one of the SRAMs in size, a third SRAM, which comprises the FIFO 20 (comprising two single port memory units 22 and 23) and is indicated by a third curve 106, is the second largest one of the SRAMs in size, and a fourth SRAM, which comprises the FIFO 10 (comprising the dual port memory unit 12) and is indicated by a fourth curve 108, is the largest one of the SRAMs in size.

In microprocessor design, gate count refers to the number of transistor switches, or gates, that are needed to implement a design. Even with today's process technology providing what was formerly considered impossible numbers of gates on a single chip, gate counts remain one of the most important overall factors in the end price of a chip. Designs with less gates will typically cost less, and for this reason gate count remains a commonly used metric in the industry. In conclusion, having the same data storage capacity, a circuit design comprising a FIFO of the present invention (the FIFO 30 or the FIFO 60) is cheap than another circuit design comprising a FIFO of the prior art (the FIFO 10 or the FIFO 20).

In contrast to the prior art, the present invention can provide a FIFO comprising a single port memory unit, a configurable write buffer, an arbiter, and a write blocking logic, which has a capability to control the configurable write buffer to store data transferred from a first computer system first and control the configurable write buffer to transfer its stored data to the single port memory unit according to a remaining data storage capacity of the configurable write buffer. After the configurable write buffer being moderately adjusted in size to meet a specific demand, a circuit comprising the FIFO can have a small gate count and is cheap.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A synchronous memory device with a single port memory unit, the synchronous memory device comprising:
the single port memory unit for storing data according to a predetermined clock;
a configurable write buffer electrically connected to the single port memory unit for storing data according to the predetermined clock and for transferring its stored data to the single port memory unit according to the predetermined clock;
a write blocking logic electrically connected to the configurable write buffer for estimating a remaining data storage capacity of the configurable write buffer and controlling the configurable write buffer to store data according to the predetermined clock, and for controlling the configurable write buffer to transfer its stored data to the single port memory unit according to a write acknowledge signal; and
an arbiter electrically connected to the write blocking logic and the single port memory unit for generating the write acknowledge signal.

2. The synchronous memory device of claim 1, wherein the write blocking logic comprises:
a first counter for counting the remaining data storage capability of the configurable write buffer;
a write comparator electrically connected to the first counter for comparing the remaining data storage capacity of the configurable write buffer counted by the first counter with a first predetermined count value and controlling the configurable write buffer to store data;
a read comparator electrically connected to the first counter for comparing the remaining data storage capacity of the configurable write buffer counted by the first counter with a second predetermined count value and controlling the configurable write buffer to transfer its stored data to the single port memory unit;
a write select counter electrically connected to the first counter for counting how many data the configurable write buffer has ever stored and generating a write select value;
a read select counter electrically connected to the first counter for counting how many data the configurable write buffer has ever transferred to the single port memory unit and generating a read select value;
and the configurable write buffer comprises:
a plurality of buffer modules for storing data;
a demultiplexer electrically connected to the buffer modules for storing data to one of the buffer modules according to the write select value; and
a multiplexer electrically connected to the buffer modules for transferring data stored in one of the buffer modules to the single port memory unit according to the read select value.

3. The synchronous memory device of claim 2, wherein the first counter has an initial count value equal to how many data the configurable write buffer can store and downward counts the remaining data storage capacity of the configurable write buffer, and the first predetermined count value is equal to zero.

4. The synchronous memory device of claim 3, wherein the write comparator controls the configurable write buffer to stop storing data when comparing that the remaining data storage capacity of the configurable write buffer is equal to zero.

5. The synchronous memory device of claim 3, wherein the read comparator controls the configurable write buffer to stop transferring its stored data to the single port memory unit when comparing that the remaining data storage capacity of the configurable write buffer is equal to how many data the configurable write buffer can store.

6. The synchronous memory device of claim 2, wherein the write select counter downward counts how many data the configurable write buffer has ever stored and generates the write select value.

7. The synchronous memory device of claim 2, wherein the read select counter downward counts how many data the configurable write buffer has ever transferred to the single port memory unit and generates the read select value.

8. A synchronous\asynchronous memory device with a single port memory unit, the synchronous\asynchronous memory device comprising:
the single port memory unit for storing data according to a read clock;
a configurable write buffer electrically connected to the single port memory unit for storing data according to a write clock and for transferring its stored data to the single port memory unit according to the read clock;
a write blocking logic electrically connected to the configurable write buffer for estimating a remaining data storage capacity of the configurable write buffer and controlling the configurable write buffer to store data according to the write clock, and for controlling the configurable write buffer to transfer its stored data to the single port memory unit according to a write acknowledge signal; and
an arbiter electrically connected to the write blocking logic and the single port memory unit for generating the write acknowledge signal.

9. The synchronous\asynchronous memory device of claim 8, wherein the write blocking logic comprises:
a write counter for counting the remaining data storage capability of the configurable write buffer;
a read counter for counting how many data in the configurable write buffer ready to be transferred to the single port memory unit;
a read\write synchronizer electrically connected between the write counter and the read counter for changing signals synchronizing with the read clock to signals synchronizing with the write clock;
a write\read synchronizer electrically connected between the write counter and the read counter for changing signals synchronizing with the write clock to signals synchronizing with the read clock;
a write comparator electrically connected to the write counter for comparing the remaining data storage capacity of the configurable write buffer counted by the write counter with a first predetermined count value and controlling the configurable write buffer to store data;
a read comparator electrically connected to the read counter for comparing how many data in the configurable write buffer ready to be transferred to the single port memory unit with a second predetermined count value and controlling the configurable write buffer to transfer its stored data to the single port memory unit according to the read clock;
a write select counter electrically connected to the write counter for counting how many data the configurable write buffer has ever stored and generating a write select value;
a read select counter electrically connected to the read counter for counting how many data the configurable write buffer has ever transferred to the single port memory unit and generating a read select value;
and the configurable write buffer comprises:
a plurality of buffer modules for storing data;
a demultiplexer electrically connected to the buffer modules for storing data to one of the buffer modules according to the write select value; and
a multiplexer electrically connected to the buffer modules for transferring data stored in one of the buffer modules to the single port memory unit according to the read select value.

10. A computer system comprising:
a first computer operating on a first clock;
a second computer operating on a second clock different from the first clock; and
a memory device comprising:
a single port memory unit for storing data according to the first clock;
a configurable write buffer electrically connected to the single port memory unit for storing data transferred from the first computer according to the first clock and for transferring its stored data to the single port memory unit according to the second clock;
a write blocking logic electrically connected to the configurable write buffer for estimating a remaining data storage capacity of the configurable write buffer and controlling the configurable write buffer to store data transferred from the first computer according to the first clock, and for controlling the configurable write buffer to transfer its stored data to the single port memory unit according to a write acknowledge signal; and
an arbiter electrically connected to the write blocking logic and the single port memory unit for generating the write acknowledge signal.
